(19) United States
(12) Patent Application Publication
(10) Pub. No.: US 2026/0154174 A1
(43) Pub. Date: Jun. 4, 2026

(54) LARGE LANGUAGE MODELS (LLMS) FOR NARRATIVE TEXT EVALUATION

(71) Applicant: eBay Inc., San Jose, CA (US)

(72) Inventors: Hee Jin Lee, Austin, TX (US); Luchao JIN, Houston, TX (US); Morteza MOAZAMI GOUDARZI, Cambridge, MA (US)

(21) Appl. No.: 18/967,270

(22) Filed: Dec. 3, 2024

(51) Int. Cl. G06F 11/34

(52) U.S. Cl. CPC G06F 11/3409

(57) ABSTRACT

A generative model evaluator is built to assess the performance of generative models. An example method involves providing a set of guidelines for evaluating generative model outputs, a training data set with inputs and initially scored outputs, and an evaluation prompt. Using an evaluation model, a model-determined evaluation score is generated for the outputs. The optimization engine identifies differences between the initial evaluation scores and model-determined evaluation scores, and determines whether a difference is from an error in the initial evaluation score, the model-determined evaluation score, or the guidelines. Based on the determined error, a modification is made to the initial evaluation score, the set of guidelines, or the evaluation prompt. The process is iteratively continued using the modifications to optimize the evaluator, which can include the optimized evaluation prompt and the optimized set of guidelines.

### BACKGROUND

Generative models include large language models (LLMs). Often, LLMs are advanced artificial intelligence systems designed to understand, generate, and modify human language. LLMs are typically trained on vast data sets comprising text from many diverse sources, enabling them to perform a wide range of language-related tasks such as translation, summarization, and question-answering. Many LLMs utilize deep learning techniques, such as transformer architectures, to achieve high levels of accuracy and fluency in natural language processing.

### SUMMARY

At a high level, the technology generally relates to generating a generative model evaluator. The generative model evaluator may be used to evaluate the output of a generative model based on the input to determine an evaluation score that may indicate the performance of the generative model.

An example method involves initially providing a set of guidelines for evaluating a generative model output. The set of guidelines may define the criteria for the generative model output. A training data set that includes generative model inputs and initially scored generative model outputs is also provided. Further provided is an evaluation prompt, e.g., which incorporates or otherwise defines all the set of guidelines, that is configured to cause a generative evaluation model to evaluate and score a generative model output.

Using the evaluation model, a model-determined evaluation score is generated for the generative model output using the evaluation prompt. The optimization engine then determines whether any differences between the initial evaluation score and the model-determined evaluation score are due to errors in the initial evaluation score, the guidelines, or the evaluation prompt.

If the difference is due to an initial evaluation score error, the initial evaluation score of the training data set is modified. If the error is a guideline error, the set of guidelines is updated. If the difference is due to an error in the evaluation prompt, the evaluation prompt is adjusted.

The modified set of guidelines or the evaluation prompt can be provided back to the evaluation model, and the process above is repeated. This iterative process optimizes the evaluation prompt and the set of guidelines. The optimized evaluation prompt and the optimized set of guidelines can be applied to a generative model, such as the evaluation model, to evaluate the output of another generative model.

This summary is intended to introduce a selection of concepts in a simplified form that is further described in the detailed description section of this disclosure. The summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment suitable for optimizing an evaluator for evaluating outputs of generative models, in accordance with an aspect described herein;

FIG. 2 illustrates a flow chart providing an example in which a training data set is generated, in accordance with an aspect described herein;

FIG. 3 illustrates a flow chart for an example of optimizing an evaluator, in accordance with an aspect described herein;

FIG. 4 illustrates a flow chart for using an evaluator to evaluate the output of a generative model, in accordance with an aspect described herein;

FIGS. 5-8 illustrate flow charts for various example methods for optimizing an evaluator for use in evaluating generative model outputs, in accordance with aspects described herein; and

FIG. 9 illustrates an example computing device suitable for implementing aspects of the technology, in accordance with an aspect described herein.

### DETAILED DESCRIPTION

Evaluating the output generated by generative models has become an essential task in developing and enhancing such models. Evaluation of a generative model's output directly impacts the development and improvement of the model, such as large language models (LLMs), among other generative models that can understand and output text. In general, such models are designed to understand and produce text responses, and thus, their effectiveness depends on the quality and accuracy of their outputs. Evaluating these outputs helps ensure that the models are generating coherent and well-structured texts, which is needed when developing and improving the models, along with applying them for their practical use in various fields.

Traditionally, determining how good a text output is, and how well it is formatted, has been challenging. One challenge is the development of unambiguous evaluation criteria or guidelines. Due to the subjective nature of narrative text evaluation, creating reliable gold standard ratings data is difficult. Different evaluators may have varying opinions on what constitutes a good output, leading to inconsistencies and potential biases in the evaluation process. Clear guidelines help ensure that evaluations are consistent and objective, providing a reliable basis for improving the generative models.

Another challenge is the manual evaluation of narrative texts. This process demands considerable time and effort from human evaluators, who must read and score each output based on the guidelines. Manual evaluation is not only time-consuming but also prone to errors, as human evaluators can make mistakes or have differing interpretations of the guidelines. This variability can result in inconsistent evaluations, making it difficult to accurately assess and improve the performance of generative models.

Further, technical challenges associated with evaluating generative model outputs are multifaceted. One key challenge is ensuring that the evaluation criteria are comprehensive and aligned with the desired outcomes of the model. This is because a machine or model preforming the evaluation typically requires stricter, literal guidance to properly evaluate the models. For instance, if the evaluation criteria do not adequately capture the nuances of good narrative structure or the relevance of content, the feedback provided to the model by the evaluator during training may be misleading. This can result in a model that performs well according to flawed criteria but fails to meet real-world expectations.

Another technical challenge is the integration of evaluation feedback into the training process. Generative models rely on iterative training cycles where a model's parameters are adjusted based on the evaluation of its outputs. If the evaluation of the outputs is not accurate or consistent, the training data may introduce biases into the model. This can hinder the model's ability to learn effectively and generalize from the training data, ultimately degrading its performance.

Additionally, the complexity of narrative text outputs poses a challenge for automated evaluation systems. Narrative texts often involve intricate structures, context-dependent meanings, and stylistic elements that are difficult for a machine or model to quantify with simple metrics. Developing sophisticated evaluation algorithms that can accurately assess these aspects requires advanced natural language processing techniques.

Moreover, an evaluator that can better evaluate and score narrative generative model outputs leads to more efficient computer processing and generation of higher-quality text outputs because it can be employed to provide feedback when training or use other generative models. This helps ensure that models learn to produce coherent and contextually relevant texts, which reduces the need for extensive post-processing and corrections. As a result, the computing device is improved because it can generate high-quality outputs with fewer resources, enhancing overall system performance and reliability. This efficiency allows the device to more effectively handle complex tasks.

As will be further described, an evaluator for evaluating textual outputs of generative models can be optimized using an iterative process. Initially, a set of guidelines can be created. The set of guidelines may include criteria that define the output of a model, such as the length, format, or other aspects of the output.

An initial set of training data is also created. The initial training data set can include generative model inputs to a generative model and their respective generative model outputs. The training data set may also include initial evaluation scores for the outputs using the criteria. These may be human scored or machine scored, or a combination of both. In an aspect, the initial training data set includes initial human evaluation scores of the outputs based on a set of guidelines for the outputs.

Further, an evaluation prompt may be generated. The evaluation prompt may be generated from the set of guidelines (e.g., include the set of guidelines as an instruction), an output, a request to evaluate the output with respect to the guidelines, and any other information for instructing a generative model to evaluate the output. Through an iterative process, one or more of the guidelines, the initial evaluation scores, and the evaluation prompt are modified to optimize them for use as an evaluator to evaluate outputs of other generative models.

To optimize an evaluator, an evaluation model, which may be a generative model, such as an LLM, can be used. The evaluation prompt may be provided to the evaluation model, along with an input and output of the training data set, and the set of guidelines. The evaluation prompt may instruct the evaluation model to generate a model-determined evaluation score for the output with respect to the set of guidelines. In some aspects, the evaluation prompt instructs the evaluation model to provide a rationale, which may include features of the generative model output on which the evaluation model determined the model-determined evaluation score.

The initial evaluation score from the training data set and the model-determined evaluation score from the evaluation model can be compared to determine whether there is a difference between the scores. If there is a difference, then the rationale may be used to determine whether there is an error with the initial evaluation score (an initial evaluation score error), the set of guidelines (a guideline error), or with the evaluation prompt (an evaluation prompt error). As an example, if the rationale matches the set of guidelines, the error may be with the initial evaluation score. If the generative model output that is being evaluated includes a feature that is not included in the set of guidelines (e.g., the generative model output includes a bulleted format but the guidelines do not specify a particular type of format), and the rationale identifies the feature on which the model-determined evaluation score is based, then the error may be with the set of guidelines. Additional information (also referred to as an output criteria) can be requested to resolve the guideline error. Finally, if the rationale includes a criteria that is not included in the set of guidelines and the criteria is relied on when generating the model-determined evaluation score, then the error may be with evaluation prompt.

Based on the error type, one of the initial evaluation scores, the set of guidelines, and the evaluation prompt may be modified. The modified data may be included back as inputs to the evaluation model to iteratively perform the process again, further optimizing the guidelines and the prompt, each of which can be provided as part of the optimized evaluator for evaluating the output of another generative model.

For instance, a first generative model can be used to generate a narrative text output. The first generative model may be the model for which performance is to be determined using the evaluator. The evaluator, which may include the optimized evaluation prompt (sometimes referred to as the modified evaluation prompt), the optimized set of guidelines (sometimes referred to as the modified set of guidelines), and a second generative model, can be used to evaluate the output of the first generative model. To do so, the output, and sometimes also the input, of the first generative model may be provided to the second generative model, along with the optimized evaluation prompt and the optimized set of guidelines. The output of the evaluator, using the second generative model, may be the evaluation score for the first generative model. This can be used to determine the performance of the first generative model and adjust the first generative model to modify the performance accordingly.

It will be realized that the methods previously described are only examples that can be practiced from the description that follows, and the examples are provided to more easily understand the technology and recognize its benefits. Additional examples are now described with reference to the figures.

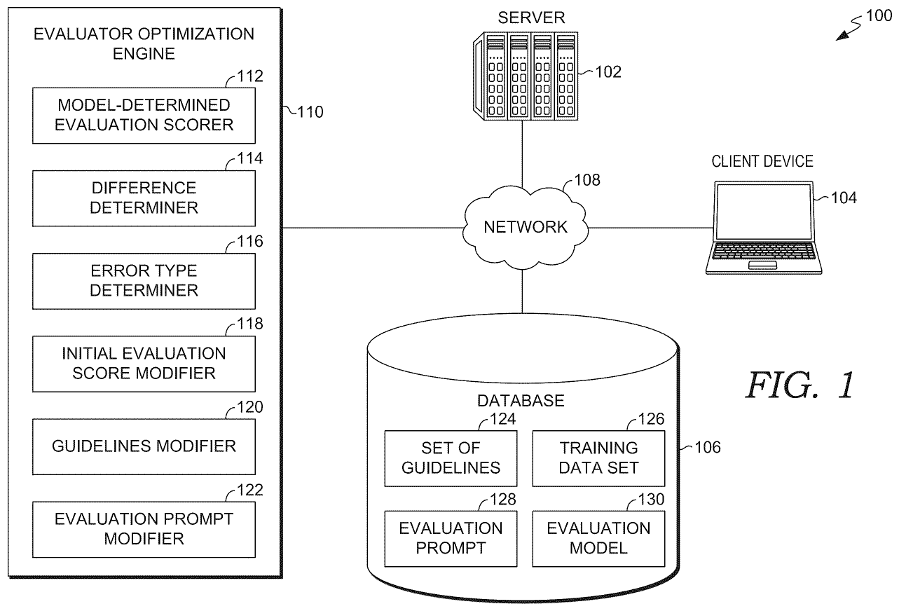

FIG. 1 provides an example operating environment 100 suitable for optimizing an evaluator for evaluating outputs of generative models. Among other components or engines not shown, operating environment 100 comprises server 102, client device 104, and database 106, which are communicating via network 108. Such devices may be configured to implement aspects of evaluator optimization engine 110.

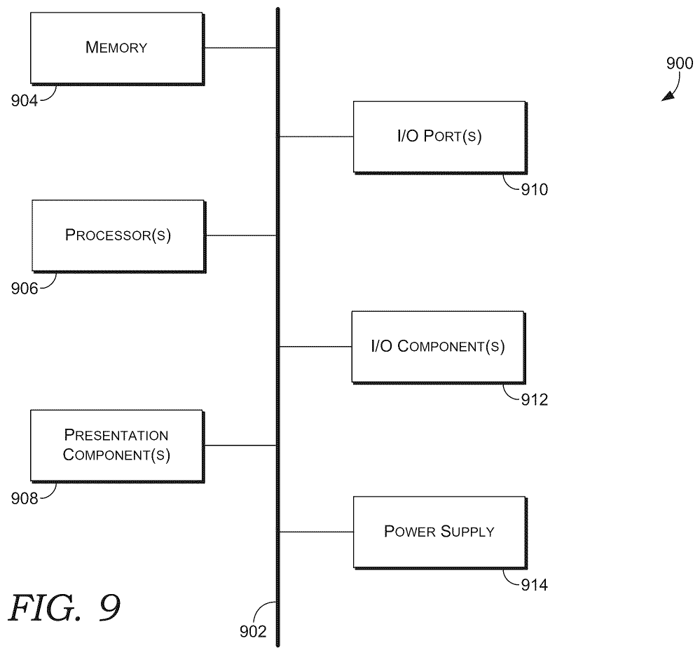

Generally, server 102 is a computing device that implements functional aspects of operating environment 100, such as one or more functions of evaluator optimization engine 110 for optimizing or using an evaluator. One suitable example of a computing device that can be employed as server 102 is described as computing device 900 with respect to FIG. 9.

Client device 104 is generally a computing device, such as computing device 900 of FIG. 9. Client device 104 may perform various functions for optimizing or using an evaluator. Client device 104 may receive inputs, such as a set of guidelines, information included within the training data, or other like information, for optimizing the evaluator. In aspects, client device 104 may perform one or more functions described with respect to evaluator optimization engine 110.

As with other components of FIG. 1, server 102 and client device 104 are each intended to represent one or more devices. In implementations, computing device 104 is a client-side or front-end device, and server 102 represents a back-end or server-side device. It will be understood that some implementations of the technology will comprise either a client-side or front-end computing device, a back-end or server-side computing device, or both, executing any combination of functions for document source detection. FIG. 1 is simply one example illustration of a computing environment in which the technology may be employed, although it will be recognized that other arrangements of devices and functions may be used with the technology as well. All are intended to be within the scope of the present disclosure, as will be further noted.

Database 106 generally stores information, including data, computer instructions (e.g., software program instructions, routines, or services), or models used in embodiments of the described technologies. Although depicted as a single database component, database 106 may be embodied as one or more databases or may be in the cloud.

Network 108 may include one or more networks (e.g., public network or virtual private network [VPN]), as shown with network 108. Network 108 may include, without limitation, one or more local area networks (LANs), wide area networks (WANs), or any other communication network or method.

To optimize an evaluator suitable for evaluating the output of a generative model, evaluator optimization engine 110 may employ model-determined evaluation scorer 112, difference determiner 114, error type determiner 116, initial evaluation score modifier 118, guidelines modifier 120, and evaluation prompt modifier 122. These functional components are intended to be illustrative, and it will be understood that in some aspects of the technology, more or fewer components may be used, and components may perform a variety of different functions and combination of functions.

Initially, set of guidelines 124, training data set 126, and evaluation prompt 128 may be generated and stored. In an aspect, evaluator optimization engine 110 optimizes an evaluator by iteratively modifying a set of guidelines 124, training data set 126, and evaluation prompt 128. Once modified, the set of guidelines 124 and evaluation prompt 128 can be used with a generative model as part of an evaluator for evaluating the outputs of other generative models.

In general, the set of guidelines includes criteria that define a generative model output. This may include criteria that define features to be included in the output and criteria that define features to be excluded from the output. In some cases, the set of guidelines may include general criteria that define the output and use-specific criteria that define the output when the model is used for a specific purpose. A set of guidelines, such as an initial set of guidelines, can be created and stored as set of guidelines 124.

Some example general criteria include output length (e.g., number of sentences, number of paragraphs, word count); output format (e.g., use of headings and subheadings, bullet points or numbered lists, sections such as introduction, body, conclusion); font and text style (e.g., font type such as Arial or Times New Roman; font size such as 12 point; text alignment such as left, center, justified; use of bold, italics, or underlining); content quality (e.g., relevance to the prompt or topic, coherence and logical flow of ideas, grammar and spelling accuracy, use of appropriate vocabulary and tone, e.g., whether to use contractions, abbreviations, or acronyms); structural elements (e.g., presence of a clear thesis statement or main idea, use of supporting evidence or examples, logical transitions between paragraphs and sections, conclusion that summarizes key points); stylistic elements (e.g., consistency in narrative voice and style, use of literary devices such as metaphors and similes, engagement, and readability); and contextual appropriateness (e.g., adherence to the specified context or scenario, sensitivity to cultural and social norms, appropriateness for the intended audience); among other examples. Any of this criteria may be included in the guidelines in any combination, and with other criteria not listed.

Some examples of use-specific criteria include summarizing client history (e.g., including of a client number, length of time the account has been active, number of transactions or interactions, number of returns or complaints, key milestones or significant events in the client relationship); generating technical reports (e.g., inclusion of relevant data points and metrics, use of technical terminology or jargon, accuracy of calculations and data analysis, clear presentation of findings and conclusions, compliance with industry standards and regulations); creating marketing content (e.g., alignment with brand voice and messaging, inclusion of key product features and benefits, use of persuasive language and calls to action, target audience appropriateness, integration of visual elements such as images and infographics); drafting legal documents (e.g., adherence to legal formatting and structure, inclusion of necessary clauses and provisions, accuracy of legal terminology, compliance with jurisdiction-specific laws and regulations, clarity and precision in language); reviewing academic papers (e.g., proper citation of sources and references, inclusion of a thesis statement and supporting arguments, logical flow and coherence of ideas, use of customary academic language and style, adherence to formatting guidelines such as APA (American Psychological Association) or MLA (Modern Language Association of America)); generating customer service responses (e.g., personalization with customer name and details, addressing the specific issue or query raised, providing actionable solutions, maintaining a professional tone, including follow-up steps and contact information); and generating news articles (e.g., inclusion of who, what, when, where, why, use of an engaging headline, accuracy and reliability of information, balanced and unbiased reporting, adherence to journalistic standards and ethics); among other examples. Any of this criteria may be included in the guidelines in any combination, and with other criteria not listed.

Further, an initial training data set can be generated. The initial training data set can be stored as training data set 126 in database 106. In general, training data set 126 may include generative model inputs and generative model outputs. The inputs may be in the form of prompts and comprise text or other data types. In an aspect, the outputs may comprise textual outputs. In some cases, the outputs are in a narrative text format. It will be understood that the term “generative model input” is meant to demonstrate a type of input that might be received by a generative model. It is not meant to limit the inputs of the training data set 126 to those actually having been received by a generative model. Likewise, the term “generative model output” is meant to demonstrate a type of output that might be provided by a generative model. It is not meant to limit the outputs of the training data set 126 to those actually having been provided by a generative model. As will be described, both generative model inputs and generative model outputs may be initially human generated as a standard on which models may learn. Evaluation scores may be given to the outputs according to the set of guidelines 124. The evaluation scores may be machine generated or human generated. In aspects, a set of initial evaluation scores is a human generated score of the generative model outputs based on the guidelines. The generative model outputs may be generated from generative model inputs using a generative model, which may be the same model or a different model from evaluation model 130, illustrated in database 106. Evaluation model 130 may include one or more generative models, such as an LLM.

As an example, a scoring system of 1-10 may be used. The score indicates the strength of the output relative to the criteria in the set of guidelines. For instance, the closer the output matches the guidelines, the relatively greater the score. Other scoring systems may be used.

For instance, a feature of the output may match a criteria in the guidelines when the feature is presented as being defined by the criteria. For example, if a criteria of the guidelines requires the output to have 10 sentences, and a feature of the output is 10 sentences, then this feature of the output matches the criteria of the guidelines, as will be further described, and a portion of the overall score may be attributed to the matching criteria and feature.

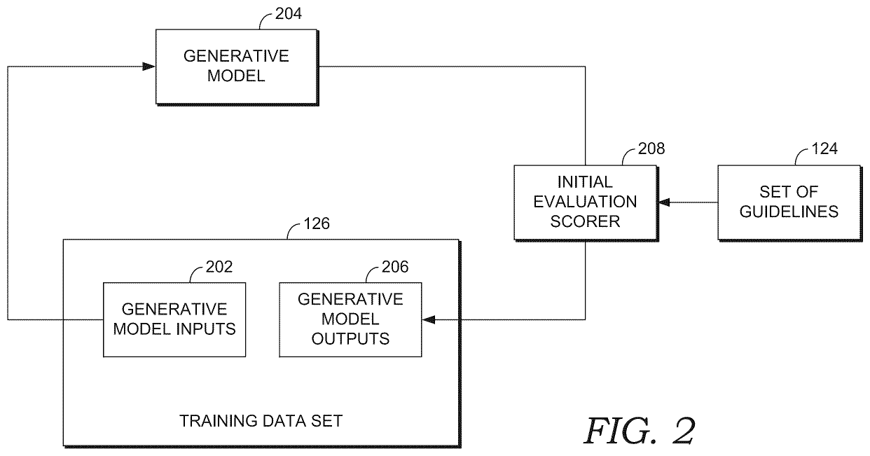

FIG. 2 illustrates a flow chart showing the generation of an example training data set 126. Generative model inputs 202 can be generated and included within training data set 126. Generative model inputs 202 may include input prompts for a generative model, such as generative model 204. These prompts may request a specific response. One skilled in the art would appreciate the vast numbers of prompts that may be provided as inputs to generate a specific response. For instance, a prompt that may be part of a generative model input might request a summary of a document, generate a report, draft an email, create a presentation, write a proposal, develop content, analyze data, create an agenda, formulate FAQs (frequently asked questions), and so forth. These are just some examples of the generative model inputs that can be provided as generative model 204.

Generative model inputs 202 can be provided to generative model 204 to generate generative model outputs 206. The generative model outputs 206 corresponding to generative model inputs 202 may be provided as part of training data set 126 as well. In aspects, each of the generative model outputs 206 is given an evaluation score. As previously noted, the evaluation score may be a machine (e.g., a model) scored evaluation of the generative model outputs 206 according to a set of guidelines 124, or they may be human scored, or a combination of both. In aspects, the evaluation scores of the generative model outputs 206 may be initial evaluation score 208. As will be described, the initial evaluation score 208 may be provided as initial inputs when optimizing an evaluator. During the course of optimizing an evaluator, one or more of the initial evaluation score 208 may be modified.

Regarding training data set 126, while in an aspect, generative model inputs 202 may be machine generated or human generated. Likewise, generative model outputs 206 may be machine generated or human generated. Training data set 126 may comprise any combination of machine generated or human generated training data, which may be modified during optimization as will be described. Thus, as an example, the initial generative model inputs 202 may comprise human generated inputs. The corresponding generative model outputs 206 may be generated by a machine executing a generative model or may be human generated, or any combination thereof, for use as training data when optimizing an evaluator.

Continuing again with FIG. 1, additionally, evaluation prompt 128 may be generated for use during optimization of the evaluator. As will be described, evaluation prompt 128 may be modified during an iterative optimization process. As such, evaluation prompt 128 can be generated by a machine (e.g., a model) or a human. In some aspects, an initial evaluation prompt is human generated and provided as evaluation prompt 128. In general, evaluation prompt 128 is a specific instruction provided to a generative model, such as evaluation model 130, as will be further discussed. The evaluation prompt may direct the generative model to assess and score the output in accordance with the provided guidelines. Evaluation prompt 128 is configured (e.g., written) to facilitate the evaluation of a generative model output, such as an output of training data set 126 during optimization or the output of another generative model when employed as part of an evaluator. In aspects, the evaluation prompt may be configured (e.g., written) according to the set of guidelines and a generative model output when provided as an input to a generative model to evaluate and score the output. As such, the evaluation prompt 128 may be generated from the set of guidelines 124 by including or otherwise defining the set of guidelines 124 within at least a portion of the evaluation prompt 128.

In an aspect, evaluation prompt 128 may include instructions for a generative model, such as evaluation model 130, to provide a rationale. The rationale may identify features of the generative model output on which the evaluation score is based. An example rationale output is as follows: “The summary accurately captures the customer's main concern about their account being restricted. However, it lacks specific details that might be present in the webform, such as the customer's account ID or any reference number related to the restriction. Without this information, the summary might not fully enable eBay service representative agents to act precisely on the customer's issue. The summary is concise but could be more informative by including any additional relevant data points.” #Score: 3

In general, and throughout this disclosure, a generative model is generally a machine learning model or a combination of machine learning models that is capable of understanding content inputs and generating new content outputs. In aspects, a generative model is a type of artificial intelligence that can produce new data instances based on patterns learned from a training data set. In general, these models can be capable of generating various types of content, such as text, images, or audio, by predicting and creating outputs that resemble the training data. In a specific case, generative models are used to understand text-based inputs and output text-based responses.

Examples of generative models that can generate text-based outputs include LLMs. Generative models other than LLMs that might be used to generate textual outputs include Generative Adversarial Networks (GANs), which can be adapted for text generation, and Variational Autoencoders (VAEs), which can also be used for generating text. Additionally, Recurrent Neural Networks (RNNs) and their variants like Long Short-Term Memory (LSTM) networks have been used for text generation in some cases.

Often, a generative model, such as an LLM, is trained on extensive data sets containing diverse text from books, articles, websites, and other written sources. This enables the model to generate contextually relevant textual outputs based on the input it receives. In some cases, a generative model may be trained for a specific task. In such cases, the model may undergo fine-tuning using a smaller, task-specific data set, allowing the model to adapt its general language understanding to the nuances of the particular task.

To optimize an evaluator, evaluator optimization engine 110 may access a set of guidelines 124, training data set 126, and evaluation prompt 128 for use with evaluation model 130, which may be a generative model. At a high level, evaluation model 130 is used to score the outputs in the training data. The score generated by evaluation model 130 can be compared to the score, e.g., the initial score or a prior modified score, for the generative model outputs stored in a training data set. If there is a difference between the scores, the difference can be attributed to an error in the initial evaluation score, an error in the set of guidelines, or an error in the evaluation prompt. Based on the error type, the initial evaluation score, the set of guidelines, or the evaluation prompt can be modified and stored at database 106.

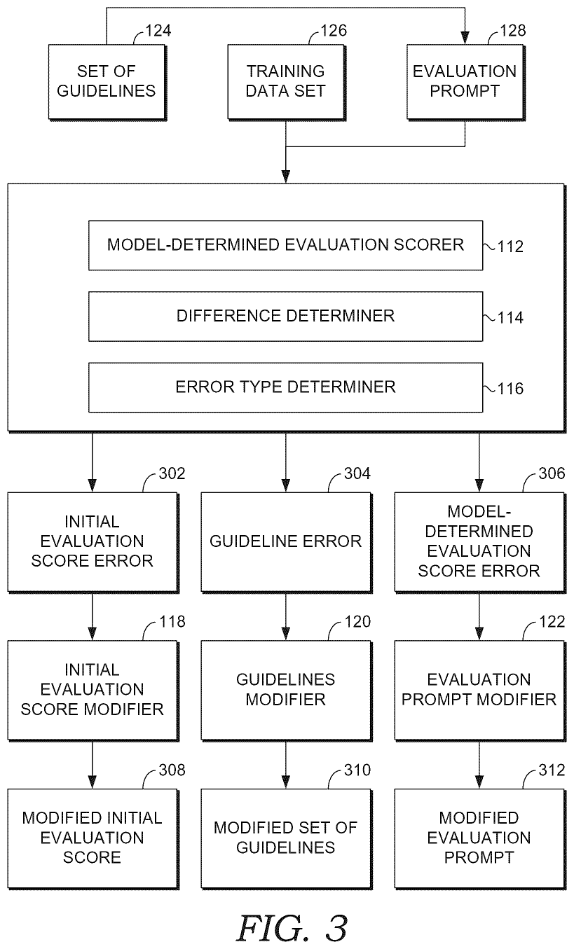

As noted, evaluator optimization engine 110 of FIG. 1 can be used to optimize an evaluator for evaluating the output of a generative model. FIG. 3 illustrates a flow chart with an example process by which components of evaluator optimization engine 110 optimize an evaluation prompt, such as evaluation prompt 128 and a set of guidelines, such as set of guidelines 124. Reference is made generally to both figures.

To begin, model-determined evaluation scorer 112 uses evaluation model 130 to determine a model-determined evaluation score for the generative model outputs within training data set 126. To do so, a generative model input and generative model output from training data set 126, and evaluation prompt 128 (e.g., generated from the set of guidelines 124) may be provided to evaluation model 130. Generally, evaluation prompt 128 instructs evaluation model 130 to evaluate and score the generative model output according to the set of guidelines 124.

In some cases, evaluation model 130 may provide a rationale for the model-determined evaluation score as directed by evaluation prompt 128. As an example, the rationale may identify that the output feature is a bulleted format. If the criteria of the set of guidelines identifies a bulleted format for the output, the relative score may be increased by evaluation model 130 as identified in the rationale, and the rationale may identify the evaluation, or to what degree, the score was increased because it matched the bulleted format feature of the output to the bulleted criteria of the set of guidelines. In a similar example, the rationale may identify that the output feature is in bulleted format, but the criteria of the set of guidelines identifies a non-bulleted format for the output. In this example, the relative score may be decreased by evaluation model 130 as identified in the rationale, and the rationale may identify the evaluation, or to what degree, the score was decreased because the bulleted format feature of the output did not match the criteria of the set of guidelines.

Difference determiner 114 may determine whether there is a difference between the initial evaluation score of the training data set and the model-determined evaluation score provided by evaluation model 130. For instance, a difference determiner 114 may compare the model-determined evaluation score for the generative model with the initial evaluation score. In an aspect, if the scores are not the same or are outside of a threshold deviation, then a difference determiner 114 may determine there is a difference attributable to an error.

Error type determiner 116 may be employed to attribute a difference between the scored determined by difference determiner 114 to a type of error. For instance, error type determiner 116 may determine whether there was an initial evaluation score error, a guideline error, or model-determined evaluation score error.

In an aspect, error type determiner 116 may attribute the difference between the evaluation scores to an initial evaluation score error. For example, error type determiner 116 may determine (e.g., attribute) that the difference is an initial evaluation score error when the rationale generated by the evaluation model 130 matches the set of guidelines 124. As noted previously, the generative model output may have features, including any modifiable aspect of the output, such as a font type, word count, or other feature. It may also have a feature for specific information, such as a customer number, or lack of specific information. These features may match a criteria in the set of guidelines 124. The rationale may match the set of guidelines when each feature of the generative model output corresponds to a criteria in the set of guidelines 124. In some cases, there is a match when a threshold number of features corresponds to criteria of the set of guidelines 124. In general, when the rationale of the model-determined evaluation score matches the criteria of the set of guidelines 124, it is likely that the model-determined evaluation score output by the generative model more accurately reflects a true, repeatable evaluation score, and thus, where there is a difference between the model-determined evaluation score and the initial evaluation score, error type determiner 116 is more likely to attribute the error to the initial evaluation score.

In aspects, error type determiner 116 may attribute the difference between the evaluation scores to a guideline error. For example, a guideline error may be determined (e.g., attributed) when the generative model output comprises a feature not included in the set of guidelines. In general, a guideline error may result from vague or ambiguous guidelines. For instance, the set of guidelines may include contradictory criteria. The set of guidelines may have missing criteria. The set of guidelines may have unsupported criteria. As an example, the evaluation model may be optimized for summarizing activity of customer accounts. The set of guidelines may include an unsupported criteria when it includes criteria not used to support the summarizing customer account. One example in this situation may be a criteria that the output include a tracking number for shipping. Shipping tracking numbers may be immaterial to a chronological summary of customer active on an account. As such, the tracking number used when shipping an item may be unsupported for the purpose of generating a chronological customer account summary.

Thus, error type determiner 116 may determine that the generative model output comprises a feature not included in the set of guidelines when a feature has no corresponding criteria in the set of guidelines, or when the feature matches a criteria but is incongruent with another criteria, e.g., in the case of contradictory criteria.

In some cases, error type determiner 116 determines that the feature of the generative model output is used by evaluation model 130 when determining the model-determined evaluation score. This may be determined from the rationale if the rationale attributes a score increase or score decrease based on the particular feature. In such cases, error type determiner 116 may further determine there is a guideline error based on the rationale.

In aspects, error type determiner 116 may attribute the difference between the evaluation scores to a model-determined evaluation score error. For example, a model-determined evaluation score error may be determined (e.g., attributed) when evaluation model 130 bases the score on a feature of the generative model output contrary to the set of guidelines 124. For example, when a feature of the generative model output is positively evaluated (e.g., there is an increase in the model-determined evaluation score because of the presence of the feature) by evaluation model 130, and the set of guidelines 124 includes a criteria indicating the feature should not be present or should be different (e.g., a different font or length), then the feature is evaluated contrary to the set of guidelines 124. Similarly, when a feature of the generative model output is negatively evaluated (e.g., there is a decrease in the model-determined evaluation score because of the presence of the feature) by evaluation model 130, and the set of guidelines 124 includes a criteria indicating the feature should be present, then the feature is evaluated contrary to the set of guidelines.

In aspects, error type determiner 116 may determine that the feature is evaluated contrary to the set of guidelines 124 based on the rationale. For example, the model-determined evaluation score error is determined when the rationale generated by the evaluation model indicates the feature of the generative model is evaluated contrary to the set of guidelines, which may be determined by error type determiner 116 comparing the rationale to the set of guidelines and identifying criteria contrary to the evaluation indicated in the rationale.

FIG. 3 illustrates an example in which model-determined evaluation scorer 112, difference determiner 114, and error type determiner 116 are used to determine an error type when optimizing an evaluator. As illustrated, set of guidelines 124, training data set 126, and evaluation prompt 128 may be provided to model-determined evaluation scorer 112 to initially determine a model-determined evaluation score for each of the generative models of training data set 126. Difference determiner 114 may then determine whether there is a difference (e.g., an absolute difference or a difference greater than a difference threshold) between the initial evaluation score from the training data set and the model-determined evaluation score output by evaluation model 130. If there is a difference, then error type determiner 116 is used to determine an error type. In some aspects, this may be done for each of the generative model outputs (and the respective generative model inputs) of training data set 126.

As illustrated in FIG. 3, difference determiner 114 may determine there is a difference with one or more of the evaluation scores for the generative model outputs of the set of guidelines 124. Thus, error type determiner 116 may determine (e.g., attribute) an error type for the one or more evaluation scores as initial evaluation score error 302, guideline error 304, and model-determined evaluation score error 306.

When there is an initial evaluation score error, such as initial evaluation score error 302, initial evaluation score modifier 118 can be used to modify the initial evaluation score. As an example, the initial evaluation score may be modified to equal the model-determined evaluation score. In another aspect, the initial evaluation score is modified in the direction of the model-determined evaluation score. For instance, if the model-determined evaluation score is lower than the initial evaluation score, the initial evaluation score can be reduced by a predetermined or algorithmically determined amount. Likewise, if the model-determined evaluation score is greater than the initial evaluation score, the initial evaluation score can be increased by the predetermined or algorithmically determined amount. By modifying the initial evaluation score, the initial evaluation score modifier 118 generates a modified initial evaluation score, such as modified initial evaluation score 308.

When there is a guideline error, such as guideline error 304, guidelines modifier 120 can be used to modify the set of guidelines 124. For example, the set of guidelines can be modified to include a criteria, remove a criteria, or change a criteria for a generative model output. For instance, if the guideline error results from the output having a feature that is not included in the set of guidelines, the set of guidelines may be modified to include the feature as a criteria. If there are contradictory criteria, the set of guidelines may be modified to remove the contradiction, e.g., selecting one of the contradictory criteria and deleting it or changing it to comply with another of the contradictory criteria. By modifying the set of guidelines, the guidelines modifier 120 generates a modified set of guidelines, such as modified set of guidelines 310.

In aspects, guidelines modifier 120 modifies the set of guidelines 124 to include additional criteria or include additional information for a criteria already in the set of guidelines 124. In some cases, this might occur where the feature of the generative model output is not included in the set of guidelines. To include the additional criteria, guidelines modifier 120 may generate a request for output criteria. As an example, if the generative model output includes a format feature not included in the criteria, then guidelines modifier 120 may generate a request for a format type that should be used as the output criteria and included in the set of guidelines 124.

When there is a model-determined evaluation score error, evaluation prompt modifier 122 can be used to modify evaluation prompt 128. In general, if there is a model-determined evaluation score error, the evaluation prompt 128 can be modified such that the modified evaluation prompt, when provided to evaluation model 130, causes evaluation model 130 to generate another model-determined evaluation score that is closer to the initial evaluation score. As such, the evaluation prompt 128 can be modified, and the modified evaluation prompt tested by using it with evaluation model 130, along with the generative model output from the training data set and the set of guidelines. If the modified evaluation prompt causes evaluation model 130 to generate a model-determined evaluation score that is closer to the initial evaluation score, the modification prompt may be modified again. Evaluation prompt modifier 122 may continue to make modifications to the evaluation prompt 128 until the model-determined evaluation score equals, or is within a threshold distance from, the initial evaluation score. By modifying evaluation prompt 128, evaluation prompt modifier 122 generates a modified evaluation prompt, such as modified evaluation prompt 312.

The resulting outputs of initial evaluation score modifier 118, guidelines modifier 120, and evaluation prompt modifier 122 respectively include modified initial evaluation score 308, modified set of guidelines 310, and modified evaluation prompt 312, which can be stored and provided back to evaluator optimization engine 110 for use in further optimizing an evaluator for evaluating a generative model through its outputs. For instance, the modified initial evaluation score 308 can be stored within the training data set 126 and associated with the generative model from which the initial evaluation score was modified. Thus, modified initial evaluation score 308 may be provided as the initial evaluation score for one or more additional iterations using evaluator optimization engine 110. Likewise, a modified set of guidelines 310 may be stored as a set of guidelines 124, such that a modified set of guidelines 310 is provided as the set of guidelines 124 for one or more additional iterations using evaluator optimization engine 110. Moreover, modified evaluation prompt 312 can be stored as evaluation prompt 128, such that modified evaluation prompt 312 is provided as the evaluation prompt 128 for one or more additional iterations using evaluator optimization engine 110.

In aspects, after the iterations using evaluator optimization engine 110, evaluator optimization engine 110 optimizes the set of guidelines 124 and evaluation prompt 128. The optimized set of guidelines 124 and the optimized evaluation prompt 128 can be provided as part of an evaluator for evaluating a generative model based on the generative model's outputs. For instance, the evaluator comprising the optimized set of guidelines 124 and the optimized evaluation prompt 128 can be used to provide an evaluation score for a generative model output. The generative model can be modified or trained based on the evaluation score to provide a generative model having a performance capability suitable for a particular task, as measured by the evaluation score determined by the evaluator.

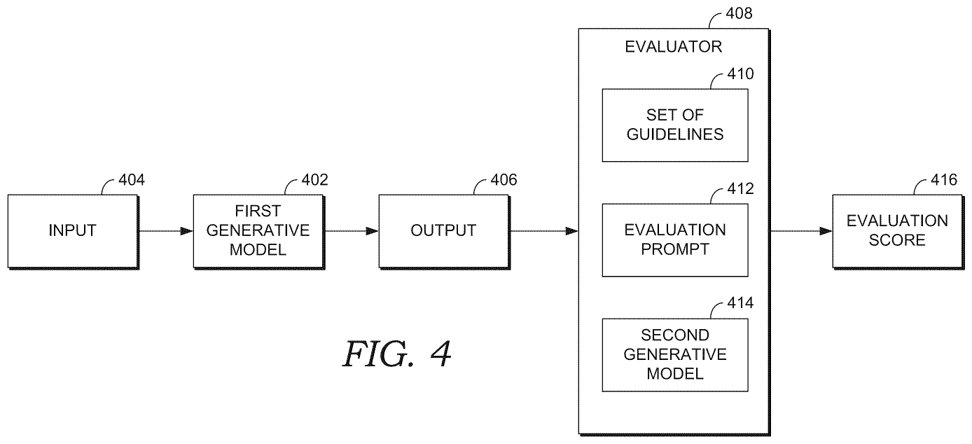

FIG. 4 is a flow chart illustrating an example process in which an example evaluator 408 is used to evaluate an output 406 of first generative model 402. In general, first generative model 402 may be any generative model described herein, such as an LLM. A first generative model 402 may be a generative model for which performance evaluation is desired. Accordingly, to evaluate the performance of the first generative model 402, evaluator 408 is employed to determine an evaluation score 416 of an output 406 from first generative model 402, thereby providing insight as to the performance of the first generative model 402, and allowing first generative model 402 to be modified or trained to enhance its performance.

In the example illustration, input 404 is provided to first generative model 402. Input 404 may be a prompt providing instructions to a first generative model 402, which generates output 406 in accordance with the instructions. To generate evaluation score 416, evaluator 408 comprises an evaluation prompt 412, which may be generated from the set of guidelines 410. These may be an optimized set of guidelines 410 and an evaluation prompt 412, as generated by evaluator optimization engine 110 using methods previously discussed. The evaluation prompt 412 may be provided as input to second generative model 414, along with output 406. In some cases, input 404 is also provided as an input to a second generative model 414. Second generative model 414 may be any generative model described herein, such as an LLM. Second generative model 414 may be different from evaluation model 130. In aspects, evaluation model 130 may be used as second generative model 414. The second generative model 414 may be different from the first generative model 402 to evaluate the output 406 of the first generative model 402. Using these inputs, the second generative model 414 generates evaluation score 416.

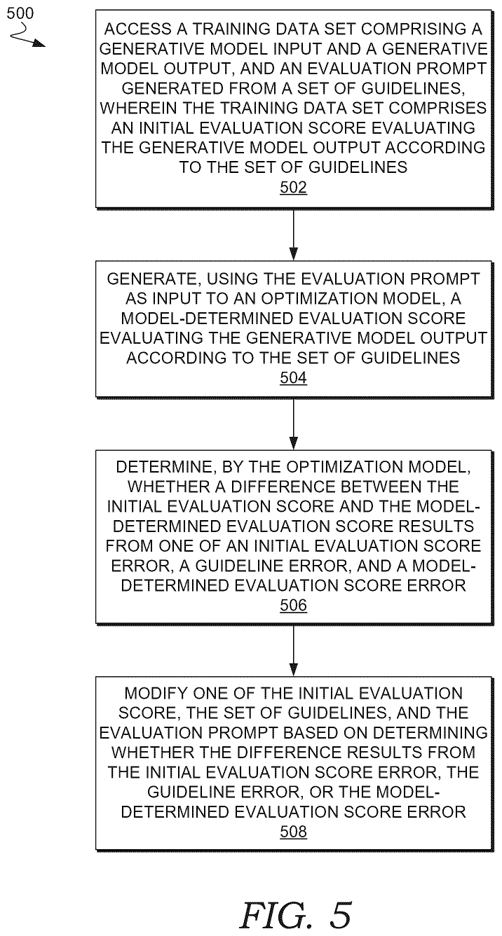

With reference now to FIGS. 5-8, block diagrams are provided respectively illustrating methods for generating a generative model evaluator by optimizing a set of guidelines and an evaluation prompt for use in evaluating the output of another generative model. Each block of the methods may comprise a computing process performed using any combination of hardware, firmware, or software. In general, computer-implemented methods can be carried out by a processor executing instructions stored in memory. The methods can also be embodied as computer-usable instructions stored on computer storage media that cause a processor to perform operations of the methods. The methods can be provided by a standalone application, a service or hosted service (standalone or in combination with another hosted service), or a plug-in to another product, to name a few possibilities. The methods may be implemented in whole or in part by components of operating environment 100.

Turning to FIG. 5, an example method for generating a generative model evaluator is provided. In block 502, method 500 accesses a training data set comprising a generative model input and a generative model output, and an evaluation prompt generated from a set of guidelines. The training data set may comprise an initial evaluation score that evaluates the generative model output according to the set of guidelines. In aspects, the initial evaluation score is human generated or machine generated (e.g., through an iterative modification process). The set of guidelines may be an initial set of guidelines that is human generated or machine generated (e.g., through an iterative modification process).

In block 504, method 500 generates, using the evaluation prompt as input to an evaluation model, a model-determined evaluation score evaluating the generative model output according to the set of guidelines. For instance, the generative model output may include features that are scored relative to criteria included in the set of guidelines to determine the model-determined evaluation score. In some cases, the model-determined evaluation score is different from the initial evaluation score. In some cases, the output comprises a rationale for the model-determined evaluation score. The rationale may indicate relative evaluation of output features and guideline criteria on which the model-determined evaluation score is based.

In block 506, method 500 determines, by the optimization engine, whether the difference between the initial evaluation score and the model-determined evaluation score results from one of an initial evaluation score error, a guideline error, or a model-determined evaluation score error. In some cases, the initial evaluation score error is determined when the rationale generated by the evaluation model matches the set of guidelines. In some cases, the guideline error is determined when the generative model output comprises a feature not included in the set of guidelines. In some cases, the model-determined evaluation score error is determined when a feature of the generative model is evaluated contrary to the set of guidelines.

In block 508, method 500 modifies one of the initial evaluation score, the set of guidelines, and the evaluation prompt based on determining whether the difference results from the initial evaluation score error, the guideline error, or the model-determined evaluation score error. For instance, when the difference results from the initial evaluation score error, the initial evaluation score may be modified. For instance, when the difference results from the guideline error, the set of guidelines may be modified. For instance, when the difference results from the model-determined evaluation score error, the evaluation prompt may be modified.

In an aspect, for modifying the set of guidelines, method 500 may include generating a request for output criteria based on determining that there is guideline error. Requested output criteria may include criteria to add to the set of guidelines or a modification to a criteria of the set of guidelines. In some aspects, the output criteria indicates criteria that may be removed from the set of guidelines. Based on the request, a response may be received that indicates the criteria. The set of guidelines may be modified to include the response to the request for the output criteria.

In an aspect, a modified set of guidelines and modified evaluation prompt is provided as a generative model evaluator. Each of the modified set of guidelines, modified evaluation prompt, and a generative model output may be provided to a second generative model to evaluate the effectiveness of the first generative model having been based on the generative model output. In doing so, the second generative model may output an evaluation score for the first generative model.

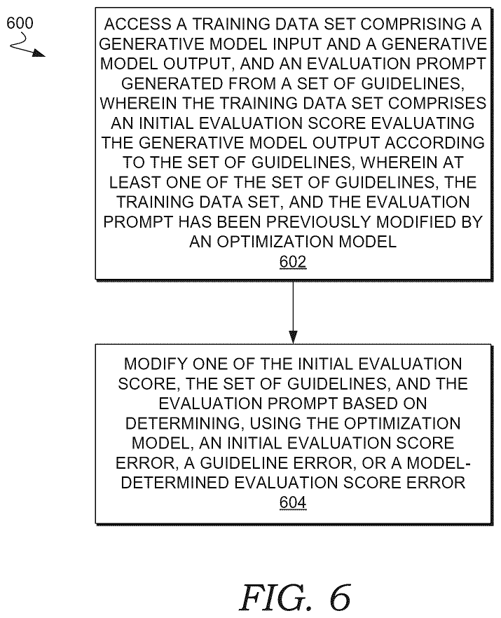

Referring now to FIG. 6, an example method for generating a generative model evaluator is provided. In block 602, method 600 accesses a training data set comprising a generative model input and a generative model output, and an evaluation prompt generated from a set of guidelines. The training data set may include an initial evaluation score evaluating the generative model output according to the set of guidelines. Moreover, at least one of the set of guidelines, the training data set, and the evaluation prompt has been previously modified by optimization engine. For instance, any one or more of the set of guidelines, training data set, and the initial evaluation score may have been previously modified one or more times using an iterative modification process for optimizing a generative model evaluator. In some aspects, the initial evaluation score may have been modified.

In block 604, method 600 modifies one of the initial evaluation score, the set of guidelines, and the evaluation prompt. In an aspect, one of the initial evaluation score, the set of guidelines, and the evaluation prompt is modified based on determining whether there is an initial evaluation score error, a guideline error, or a model-determined evaluation score error. The error type, whether the error is an initial evaluation score, a guideline error, or a model-determined evaluation score error is determined from the optimization engine.

For example, the evaluation model, using the evaluation prompt as an input, may generate a model-determined evaluation score by evaluating the generative model output according to the set of guidelines of the evaluation prompt. Based on a difference between the initial evaluation score and the model-determined evaluation score, the optimization engine may determine whether the difference results from the initial evaluation score error, the guideline error, or the model-determined evaluation score error. To do so, in some aspects, the evaluation model generates a rationale identifying the features of the generative model output and the criteria of the set of guidelines on which the model-determined evaluation score is based.

As an example, the initial evaluation score error may be determined based on the rationale matching the set of guidelines. The guideline error may be determined based on the generative model output comprising a feature not included in the set of guidelines. The model-determined evaluation score error may be determined when the rationale indicates that a feature of the generative model is evaluated contrary to the set of guidelines.

In some aspects, the method 600 further generates a request for output criteria responsive to determining that there is a guideline error. In response, the output criteria may be received, and the set of guidelines updated based on the output criteria.

In an aspect, the modified set of guidelines and the modified evaluation prompt may be provided as part of an evaluator for evaluating generative model outputs. For instance, the output of a first generative model may be evaluated using a second generative model that receives as an input the modified set of guidelines, the modified evaluation prompt, and the output of the first generative model. The second generative model may output an evaluation score for the output of the first generative model in response.

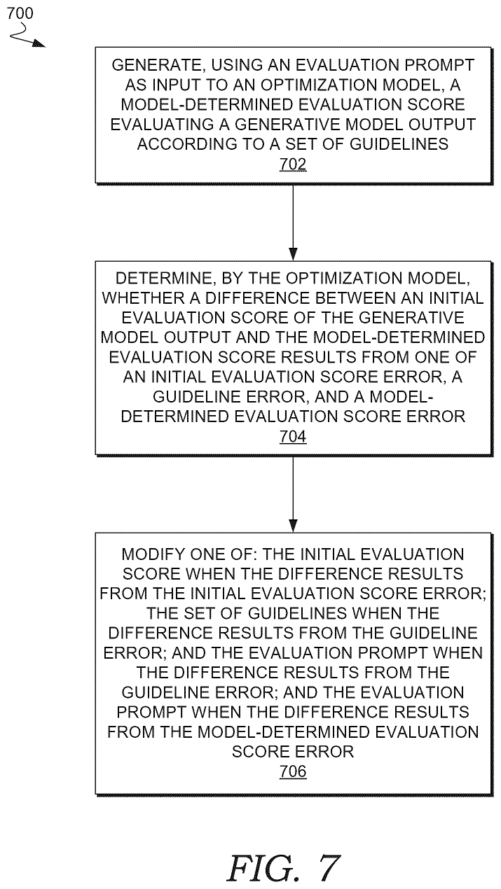

Referring now to FIG. 7, an example method for optimizing an evaluator is provided. In block 702, method 700 generates, using an evaluation prompt as input to an evaluation model, a model-determined evaluation score evaluating a generative model output according to a set of guidelines. In some aspects, the evaluation prompt has been previously modified, e.g., through an iterative process. The generative model output may be included as part of a training data set, which may include an initial evaluation score for the generative model output. The score may have been human generated or machine generated, e.g., through an iterative modification process.

In block 704, method 700 determines, by the optimization engine, whether a difference between the initial evaluation score of the generative model output and the model-determined evaluation score results from one of an initial evaluation score error, a guideline error, and a model-determined evaluation score error. In some cases, the determination is based on a rationale output by the evaluation model identifying features of the generative model output and criteria of the set of guidelines on which the model-determined evaluation score is based.

For example, the initial evaluation score error may be determined when the rationale generated by the evaluation model matches the set of guidelines. The guideline error may be determined when the generative model output comprises a feature not included in the set of guidelines. The model-determined evaluation score error may be determined when the rationale indicates that a feature of the generative model output is evaluated contrary to the set of guidelines.

In block 706, method 700 modifies one of: the initial evaluation score when the difference results from the initial evaluation score error; the set of guidelines when the difference results from the guideline error; and the evaluation prompt when the difference results from the model-determined evaluation score error.

In an aspect, when there is a guideline error, a request for output criteria can be generated and provided. Output criteria may be received responsive to the request. The received output criteria may be used to modify the set of guidelines.

In an aspect, the modified set of guidelines and the modified evaluation prompt may be used as part of an evaluator. For instance, the output of a first generative model may be evaluated using a second generative model that receives as an input the modified set of guidelines, the modified evaluation prompt, and the output of the first generative model. The second generative model may output an evaluation score for the output of the first generative model in response.

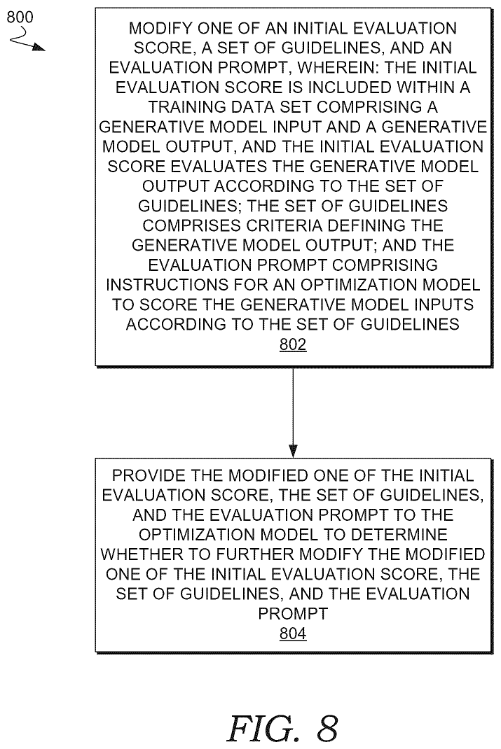

Referring now to FIG. 8, another example method for generating a generative model evaluator is provided. In block 802, method 800 modifies one of an initial evaluation score, a set of guidelines, and an evaluation prompt, wherein: the initial evaluation score is included within a training data set comprising a generative model input and a generative model output, and the initial evaluation score evaluates the generative model output according to the set of guidelines; the set of guidelines comprises criteria defining the generative model output; and the evaluation prompt comprising instructions for an evaluation model to score the generative model inputs according to the set of guidelines.

In block 804, method 800 provides the modified one of the initial evaluation score, the set of guidelines, and the evaluation prompt to the evaluation model to determine whether to further modify the modified one of the initial evaluation score, the set of guidelines, and the evaluation prompt.

Having described an overview of some embodiments of the present technology, an example computing environment in which embodiments of the present technology may be implemented is described below in order to provide a general context for various aspects of the present technology. Referring now to FIG. 9 in particular, an example operating environment for implementing embodiments of the present technology is shown and designated generally as computing device 900. Computing device 900 is but one example of a suitable computing environment and is not intended to suggest any limitation as to the scope of use or functionality of the technology. Computing device 900 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 9, computing device 900 includes bus 902, which directly or indirectly couples the following devices: memory 904, one or more processors 906, one or more presentation components 908, input/output (I/O) ports 910, input/output components 912, and illustrative power supply 914. Bus 902 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 9 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 9 and with reference to “computing device.”

Computing device 900 typically includes a variety of computer-readable media. Computer-readable media can be any available media that can be accessed by computing device 900 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 900. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 904 includes computer storage media in the form of volatile or non-volatile memory. The memory may be removable, non-removable, or a combination thereof. Example hardware devices include solid-state memory, hard drives, optical-disc drives, etc. Computing device 900 includes one or more processors that read data from various entities, such as memory 904 or I/O components 912. Presentation component(s) 908 presents data indications to a user or other device. Example presentation components include a display device, speaker, printing component, vibrating component, etc.

I/O ports 910 allow computing device 900 to be logically coupled to other devices, including I/O components 912, some of which may be built-in. Illustrative components include a microphone, joystick, game pad, satellite dish, scanner, printer, wireless device, etc. The I/O components 912 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 900. Computing device 900 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 900 may be equipped with accelerometers or gyroscopes that enable detection of motion. The output of the accelerometers or gyroscopes may be provided to the display of computing device 900 to render immersive augmented reality or virtual reality. Power supply 914 may supply power to 900 or components thereof.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

With reference back to FIG. 1, and with the figures in general, it is noted and again emphasized that any additional or fewer components, in any arrangement, may be employed to achieve the desired functionality within the scope of the present disclosure. Although the various components are shown with lines for the sake of clarity, in reality, delineating various components is not so clear, and metaphorically, the lines may more accurately be grey or fuzzy. Although some components are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to evaluator optimization engine 110, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of evaluator optimization engine 110, among other functions, may be performed by server 102, client device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the foregoing description include the following:

Aspect 1: A system, computer-readable media, or method comprising: modifying one of an initial evaluation score, a set of guidelines, and an evaluation prompt, wherein: the initial evaluation score is included within a training data set comprising a generative model input and a generative model output, and the initial evaluation score evaluates the generative model output according to the set of guidelines; the set of guidelines comprising criteria defining the generative model output; and the evaluation prompt comprising instructions for an evaluation model to score the generative model inputs according to the set of guidelines; and providing the modified one of the initial evaluation score, the set of guidelines, and the evaluation prompt to the optimization engine to determine whether to further modify the modified one of the initial evaluation score, the set of guidelines, and the evaluation prompt.

Aspect 2: A computer-implemented method for generating a generative model evaluator, the method comprising: accessing a training data set comprising a generative model input and a generative model output, and an evaluation prompt generated from a set of guidelines, wherein the training data set comprises an initial evaluation score evaluating the generative model output according to the set of guidelines; generating, using the evaluation prompt as input to an evaluation model, a model-determined evaluation score evaluating the generative model output according to the set of guidelines; determining, by the optimization engine, whether a difference between the initial evaluation score and the model-determined evaluation score results from at least one of an initial evaluation score error, a guideline error, or a model-determined evaluation score error; and modifying one of the initial evaluation score, the set of guidelines, and the evaluation prompt based on determining whether the difference results from the initial evaluation score error, the guideline error, or the model-determined evaluation score error.

Aspect 3: Aspect 1 or 2 comprising any one or more combinations of the following, wherein: (1) when the difference results from the initial evaluation score error, the initial evaluation score is modified; (2) when the difference results from the guideline error, the set of guidelines is modified; and (3) when the difference results from the model-determined evaluation score error, the evaluation prompt is modified.

Aspect 4: Any of Aspects 1-3, wherein the evaluation model generates a rationale for the model-determined evaluation score.

Aspect 5: Aspect 4, wherein the initial evaluation score error is determined when the rationale generated by the evaluation model matches the set of guidelines.

Aspect 6: Any of Aspects 4-5, wherein the guideline error is determined when the generative model output comprises a feature not included in the set of guidelines.

Aspect 7: Any of Aspects 4-6, wherein the model-determined evaluation score error is determined when a feature of the generative model is evaluated contrary to the set of guidelines.

Aspect 8: Any of Aspects 1-7, further comprising: generating a request for output criteria based on determining that there is guideline error; and modifying the set of guidelines to include a response to the request for the output criteria.

Aspect 9: One or more computer storage media storing computer-readable instructions thereon that, when executed by at least one processor, cause the processor to perform operations for generating a generative model evaluator, the operations comprising: accessing a training data set comprising a generative model input and a generative model output, and an evaluation prompt generated from a set of guidelines, wherein the training data set comprises an initial evaluation score evaluating the generative model output according to the set of guidelines, wherein at least one of the set of guidelines, the training data set, and the evaluation prompt has been previously modified by an optimization engine; and modifying at least one of the initial evaluation score, the set of guidelines, or the evaluation prompt based on determining, using the error type determiner, an initial evaluation score error, a guideline error, or a model-determined evaluation score error.

Aspect 10: Aspect 9, wherein the operations further comprise: generating, using the evaluation prompt as input to the evaluation model, a model-determined evaluation score evaluating the generative model output according to the set of guidelines; and determining, by the optimization engine whether a difference between the initial evaluation score and the model-determined evaluation score results from the initial evaluation score error, the guideline error, or the model-determined evaluation score error.

Aspect 11: Aspect 10, wherein the evaluation model generates a rationale for the model-determined evaluation score.

Aspect 12: Any of Aspects 9-11, wherein the initial evaluation score error is determined based on a rationale generated by the evaluation model when determining the model-determined evaluation score matches the set of guidelines.

Aspect 13: Any of Aspects 9-12, wherein the guideline error is determined based on the generative model output comprising a feature not included in the set of guidelines.

Aspect 14: Any of Aspects 9-13, wherein the model-determined evaluation score error is determined when a rationale generated by the evaluation model indicates that a feature of the generative model is evaluated contrary to the set of guidelines.

Aspect 15: Any of Aspects 9-14, the operations further comprise generating a request for output criteria responsive to determining that there is a guideline error.

Aspect 16: A system for generating a generative model evaluator, the system comprising: at least one processor; and one or more computer storage media storing computer-readable instructions thereon that, when executed by the at least one processor, cause the at least one processor to perform a method comprising: generating, using an evaluation prompt as input to an evaluation model, a model-determined evaluation score evaluating a generative model output according to a set of guidelines; determining, by the optimization engine, whether a difference between an initial evaluation score of the generative model output and the model-determined evaluation score results from at least one of an initial evaluation score error, a guideline error, or a model-determined evaluation score error; and modifying one of: (1) the initial evaluation score when the difference results from the initial evaluation score error; (2) the set of guidelines when the difference results from the guideline error; and (3) the evaluation prompt when the difference results from the model-determined evaluation score error.

Aspect 17: Aspect 16, wherein the evaluation model generates a rationale for the model-determined evaluation score.

Aspect 18: Aspect 17, wherein the initial evaluation score error is determined when the rationale generated by the evaluation model matches the set of guidelines.

Aspect 19: Any of Aspects 17-18, wherein the guideline error is determined when the generative model output comprises a feature not included in the set of guidelines.

Aspect 20: Any of Aspects 17-19, wherein the model-determined evaluation score error is determined when the rationale indicates that a feature of the generative model output is evaluated contrary to the set of guidelines.

Aspect 21: Any of Aspects 16-20, further comprising: generating a request for output criteria when the guideline error is determined by the optimization engine; and modifying the set of guidelines to include a response to the request for the output criteria.

Aspects 22: Any of Aspects 1-21, wherein the evaluation model is an LLM.

What is claimed is:

1. A computer-implemented method for generating a generative model evaluator, the method comprising:
accessing a training data set comprising a generative model input and a generative model output, and an evaluation prompt generated from a set of guidelines, wherein the training data set comprises an initial evaluation score evaluating the generative model output according to the set of guidelines;
generating, using the evaluation prompt as input to an evaluation model, a model-determined evaluation score evaluating the generative model output according to the set of guidelines;
determining whether a difference between the initial evaluation score and the model-determined evaluation score results from at least one of an initial evaluation score error, a guideline error, or a model-determined evaluation score error; and
modifying one of the initial evaluation score, the set of guidelines, and the evaluation prompt based on determining whether the difference results from the initial evaluation score error, the guideline error, or the model-determined evaluation score error.

2. The computer-implemented method of claim 1, wherein:
when the difference results from the initial evaluation score error, the initial evaluation score is modified;
when the difference results from the guideline error, the set of guidelines is modified; and
when the difference results from the model-determined evaluation score error, the evaluation prompt is modified.

3. The computer-implemented method of claim 1, wherein the evaluation model generates a rationale for the model-determined evaluation score.

4. The computer-implemented method of claim 3, wherein the initial evaluation score error is determined when the rationale generated by the evaluation model matches the set of guidelines.

5. The computer-implemented method of claim 3, wherein the guideline error is determined when the generative model output comprises a feature not included in the set of guidelines.

6. The computer-implemented method of claim 3, wherein the model-determined evaluation score error is determined when a feature of the generative model is evaluated contrary to the set of guidelines.

7. The computer-implemented method of claim 1, further comprising:
generating a request for output criteria based on determining there is guideline error; and
modifying the set of guidelines to include a response to the request for the output criteria.

8. One or more computer storage media storing computer-readable instructions thereon that, when executed by at least one processor, cause the processor to perform operations for generating a generative model evaluator, the operations comprising:
accessing a training data set comprising a generative model input and a generative model output, and an evaluation prompt generated from a set of guidelines, wherein the training data set comprises an initial evaluation score evaluating the generative model output according to the set of guidelines, wherein at least one of the set of guidelines, the training data set, and the evaluation prompt has been previously modified; and
modifying at least one of the initial evaluation score, the set of guidelines, or the evaluation prompt based on determining, using an optimization model, an initial evaluation score error, a guideline error, or a model-determined evaluation score error.

9. The media of claim 8, wherein the operations further comprise:
generating, using the evaluation prompt as input to the evaluation model, a model-determined evaluation score evaluating the generative model output according to the set of guidelines; and
determining whether a difference between the initial evaluation score and the model-determined evaluation score results from the initial evaluation score error, the guideline error, or the model-determined evaluation score error.

10. The media of claim 9, wherein the evaluation model generates a rationale for the model-determined evaluation score.

11. The media of claim 8, wherein the initial evaluation score error is determined based on a rationale generated by the evaluation model when determining the model-determined evaluation score matches the set of guidelines.

12. The media of claim 8, wherein the guideline error is determined based on the generative model output comprising a feature not included in the set of guidelines.

13. The media of claim 8, wherein the model-determined evaluation score error is determined when a rationale generated by the evaluation model indicates a feature of the generative model is evaluated contrary to the set of guidelines.

14. The media of claim 8, wherein the operations further comprise generating a request for output criteria responsive to determining there is a guideline error.

15. A system for generating a generative model evaluator, the system comprising:
at least one processor; and
one or more computer storage media storing computer-readable instructions thereon that, when executed by the at least one processor, cause the at least one processor to perform a method comprising:
generating, using an evaluation prompt as input to an evaluation model, a model-determined evaluation score evaluating a generative model output according to a set of guidelines;
determining whether a difference between an initial evaluation score of the generative model output and the model-determined evaluation score results from at least one of an initial evaluation score error, a guideline error, or a model-determined evaluation score error; and
modifying one of:
the initial evaluation score when the difference results from the initial evaluation score error;
the set of guidelines when the difference results from the guideline error; and
the evaluation prompt when the difference results from the model-determined evaluation score error.

16. The system of claim 15, wherein the evaluation model generates a rationale for the model-determined evaluation score.

17. The system of claim 16, wherein the initial evaluation score error is determined when the rationale generated by the evaluation model matches the set of guidelines.

18. The system of claim 16, wherein the guideline error is determined when the generative model output comprises a feature not included in the set of guidelines.

19. The system of claim 16, wherein the model-determined evaluation score error is determined when the rationale indicates a feature of the generative model output is evaluated contrary to the set of guidelines.

20. The system of claim 15, further comprising:
generating a request for output criteria when the guideline error is determined; and
modifying the set of guidelines to include a response to the request for the output criteria.
